(19) United States
(12) Patent Application Publication
(10) Pub. No.: US 2002/0129722 A1
(43) Pub. Date: Sep. 19, 2002

(54) Device for cleaning printing forms

(76) Inventors: Joachim Herrmann, Northeim (DE); Frank Schaum, Neckargemund (DE)

Correspondence Address: LERNER AND GREENBERG, P.A., POST OFFICE BOX 2480, HOLLYWOOD, FL, 33022-2480, US

(21) Appl. No.: 10/096,695

(22) Filed: Mar. 13, 2002

(30) Foreign Application Priority Data
Mar. 13, 2001 (DE) 101 11 870.8

(51) Int. Cl. B41F 35/02

(52) U.S. Cl. 101/425

(57) ABSTRACT

A device for cleaning a printing form for dry offset includes a cleaning roller settable onto and off the printing form, respective roller bearings for rotatably holding the cleaning roller at both ends thereof so that the cleaning roller is drivable, the roller bearings being displaceable perpendicularly to an axis of the cleaning roller, at least one lever joint, respectively, assigned to each of the roller bearings, and a rod operatively engageable with the lever joint for introducing a force into the lever joint.

### BACKGROUND OF THE INVENTION

1 Field of the Invention

The invention relates to a device for cleaning printing forms, more particularly, those types thereof which are intended for dry offset.

In recent times, dry offset has made great strides and increased in significance as compared with the conventional offset process. Instead of a conventional offset printing plate, wherein the non-printing areas of the printing form are wetted with water, in dry offset, a surface is used which has the property of repelling the printing ink without requiring a supply of water. The advantage of the dry offset process resides in the fact that no attention need be given to the ink/water equilibrium, which otherwise has to be set very sensitively, so that the entire printing process is consequently simpler to handle. Furthermore, an advantage is afforded in that the printing form can be produced in the printing machine by a so-called direct imaging method. The imaging is performed digitally by stripping off the ink-repelling coating of the printing form, for example by laser light, so that a surface located underneath becomes effective, that surface, in turn, having the property of picking up or accepting the printing ink. The so-called printing form cylinder can itself have a silicone-coated surface, or it can also be provided with a replaceable plate or a sleeve which is silicone-coated and is referred to hereinbelow as a printing form. Because the imaging, as opposed to the production of conventional printing plates, proceeds extremely rapidly, dry offset is particularly suitable for small print runs or editions.

A problem that exists when digitally imaging on silicone-coated printing forms is that such printing forms are extremely sensitive, and that the silicone released or detached by the exposure process and a correspondingly ink-repelling layer, respectively, have to be drawn off from the surface without damaging the non-printing areas of the printing form, for example, by scratching.

For this purpose, cleaning devices for cleaning printing forms have already become known in the prior art. U.S. Pat. No. 5,755,158 describes a cleaning device for cleaning lithographic printing plates. This device is made up of a revolving elastomer roller, which is pressable against the printing form whereon an image has been set. However, the device described therein is not suitable for cleaning silicone-coated dry-offset printing plates. It has been shown that, with such devices, either the cleaning function is not fulfilled in a perfect manner, or that damage occurs to the non-printing areas of the printing form.

### SUMMARY OF THE INVENTION

It is accordingly an object of the invention to provide a device for cleaning printing forms with which, for example, silicone-coated printing forms for dry offset can be cleaned after digital imaging, the detached or loosened silicone being removed or taken away without causing any damage to the non-printing areas of the printing form.

With the foregoing and other objects in view, there is provided, in accordance with the invention, a device for cleaning a printing form for dry offset, comprising a cleaning roller settable onto and off the printing form, respective roller bearings for rotatably holding the cleaning roller at both ends thereof so that the cleaning roller is drivable, the roller bearings being displaceable perpendicularly to an axis of the cleaning roller, at least one lever joint, respectively, assigned to each of the roller bearings, and a rod operatively engageable with the lever joint for introducing a force into the lever joint.

In accordance with another feature of the invention, the cleaning device further comprises a pneumatic cylinder for applying the force to the rod, the pneumatic cylinder having an effective axis extending parallel to the cleaning roller.

In accordance with a further feature of the invention, the lever joint is a toggle-lever joint.

In accordance with an added feature of the invention, a spring is connected into a flow of force to the roller bearings for damping a pressing force applicable via the toggle-lever joint.

In accordance with an additional feature of the invention, the cleaning device further comprises a plurality of the toggle-lever joints, of which toggle-lever joints on the drive side and on the operator side are coupled with one another so that an angular position thereof relative to one another is adjustable.

In accordance with yet another feature of the invention, the cleaning roller has a longitudinal axis, and the cleaning roller is traversible in the direction of the longitudinal axis thereof.

In accordance with yet a further feature of the invention, the cleaning roller is drivable so that a relative speed prevails between the circumferential surface thereof and the printing form.

In accordance with yet an added feature of the invention, the cleaning device further comprises a suction device for sucking particles away.

In accordance with yet an additional feature of the invention, the cleaning roller is formed with a multiplicity of boreholes opening at an outer surface of the cleaning roller, the boreholes being connected within the cleaning roller to a duct running in the cleaning roller, the duct being connectable to an external suction source.

In accordance with a concomitant feature of the invention, the suction device has at least one suction nozzle provided with at least one nozzle lip for sucking particles away, the suction nozzle running parallel to and extending over the length of the cleaning roller, and being connectable to an external vacuum source.

The invention thus comprises a cleaning roller which runs parallel to and is settable onto the printing form cylinder. It is set on pneumatically, it being possible for the pressing force to be metered finely, and to be specifically adjustable individually on the operator side and on the drive side.

One refinement of the cleaning device according to the invention lies in the pressing device that is formed, for example, by a pneumatic force unit, the effective axis of which runs parallel to the cleaning roller, and two toggle-lever joints. The toggle-lever joints then displace the two bearings of the cleaning roller in a direction towards the outer surface of the printing form cylinder to be cleaned. This construction is advantageous because it permits particularly fine pressing of the cleaning roller onto the printing form cylinder.

A further embodiment provides for the cleaning roller to execute a traversing movement, and the cleaning action, therefore, is considerably improved. The traversing movement of the cleaning roller is effected, for example, by an axial cam. The cleaning roller is advantageously coated with a surface which, on the one hand, does not damage the printing form and, on the other hand, repels dirt. The cleaning process is furthermore improved by having the coating detached or released by the cleaning roller with the assistance of a suction device extending parallel to and on both sides of the cleaning roller.

According to an additional improvement, the cleaning roller is formed with a multiplicity of boreholes, which open at the outer surface of the cleaning roller. In the interior of the cleaning roller, a duct or channel extends, which can be connected to an air supply. By a positive pressure, which produces an air flow in the outlet openings of the boreholes, the cleaning action of the device can then be improved.

Other features which are considered as characteristic for the invention are set forth in the appended claims.

Although the invention is illustrated and described herein as embodied in a device for cleaning printing forms, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a diagrammatic side elevational view of the printing-form cleaning device according to the invention; and

FIG. 2 is a reduced front elevational view of FIG. 1.

### DESCRIPTION OF THE PREFERRED EMBODIMENTS

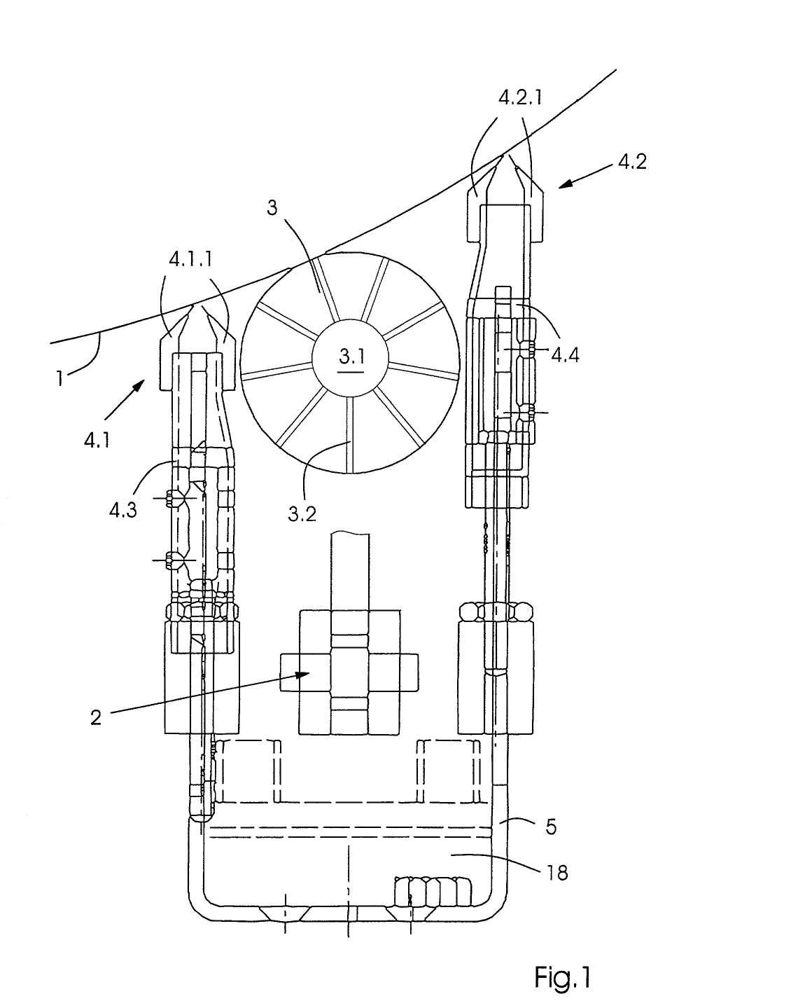

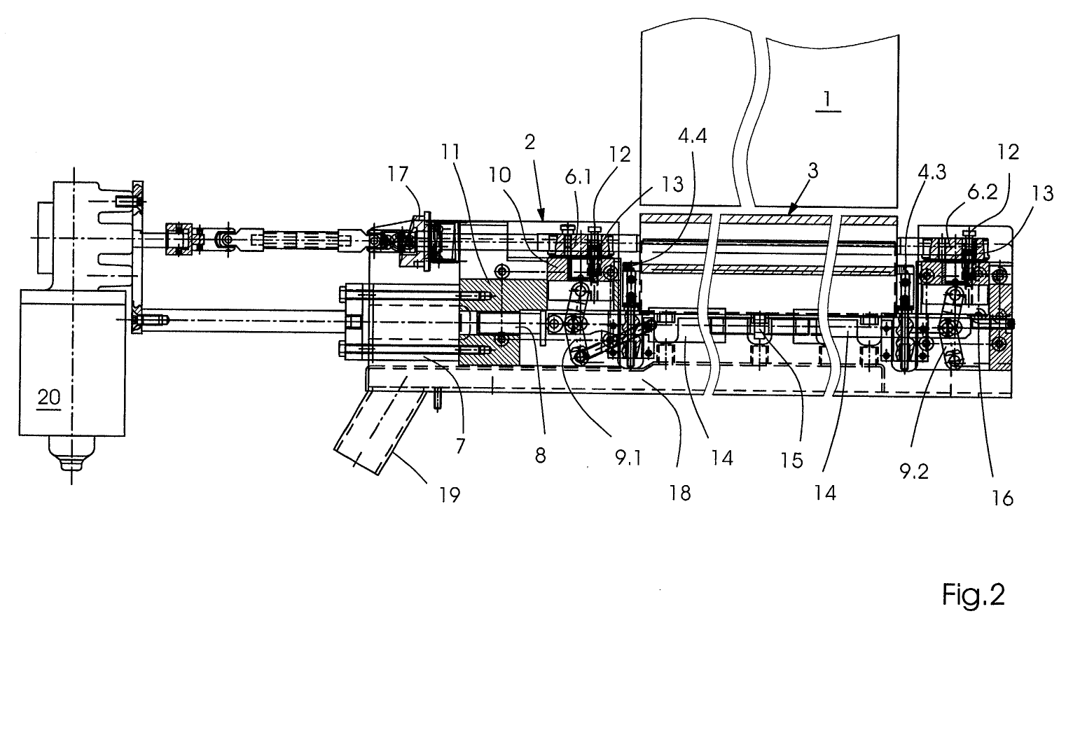

Referring now to the drawings and, first, particularly to FIG. 1 thereof, there is shown therein a printing form/printing plate 1, that is, for example, silicone-coated. Assigned thereto is a cleaning roller 3, which is set against the printing form/printing plate 1 by a pressing device 2. The printing form/printing plate 1 and the cleaning roller 3 perform a rotational movement which is advantageously in opposing directions. A rotational movement in the same direction is also possible, but a relative movement between the two surfaces is advantageous. Located in the interior of the cleaning roller 3 is a channel or duct 3.1, which is connected to the outer surface of the cleaning roller 3 via a large number of boreholes 3.2. The function of the pressing device 2 is illustrated in greater detail in FIG. 2 and will therefore be explained hereinbelow. On both sides of the cleaning roller 3, a respective suction nozzle 4.1, 4.2 is provided, which is configured as a slit nozzle, likewise running parallel to the cleaning roller 3 and extending at least approximately over the entire length of the latter. The slit nozzles 4.1 and 4.2 are formed by nozzle lips 4.1.1 and 4.2.1, respectively.

Each suction nozzle 4.1, 4.2 has a respective stop 4.3 and 4.4 assigned thereto, which limits the displacement travel of the relevant suction nozzle 4.1, 4.2 in a direction towards the printing form 1. Adjustment of the relevant suction nozzle 4.1, 4.2 relative to the printing form 1 is necessary in order to bring the suction nozzle 4.1, 4.2 as close as possible to the printing form 1 during the cleaning operation. In this regard, distances or spacings in the range of tenths of a millimeter are being considered.

During a printing operation, the suction nozzles 4.1 and 4.2 are set off the printing form 1. In order to avoid scratching the printing form 1, the nozzle lips 4.1.1 and 4.2.1 are formed of a resilient material, such as a rubber-elastic material.

A housing 5 is provided for carrying the two suction nozzles 4.1 and 4.2 which skirt the cleaning roller 3. Also provided in this housing 5 is a member for fixing the pressing device 2. In addition, the housing 5 also forms an air duct 18, via which the suction for the suction nozzles 4.1 and 4.2 is conducted.

FIG. 2 shows the cleaning roller 3, which is mounted in two roller bearings 6.1 and 6.2. The two roller bearings 6.1 and 6.2 are arranged so as to be displaceable by respective toggle-lever joints 9.1 and 9.2. The displacement is aligned in such a manner that the cleaning roller 3 is set against the printing form 1. A rod 14, which is actuated by a pneumatic cylinder 7 via a piston 8, acts against the articulation points of the toggle-lever joints 9.1 and 9.2. In order to adjust the uniform pressing force of the cleaning roller 3, the rod 14 is connected by a threaded sleeve 15. The roller bearings 6.1 and 6.2 are axially displaceably mounted in a thrust piece or trigger 10, the thrust piece 10 serving to press the cleaning roller 3 against the printing form 1 by the respective toggle-lever joint 9.1, 9.2. The thrust piece 10, like the piston 8 of the pneumatic cylinder 7, is mounted in a housing 11, which also serves for fixing the pneumatic cylinder 7. If the piston 8 acts upon the respective toggle-lever joint 9.1, 9.2, then one of the levers exerts a force directed towards the printing form 1, which results in the displacement of the thrust piece 10, and, therefore, the displacement of the respective roller bearing 6.1, 6.2 in the direction towards the printing form 1. The other lever is supported against the housing 5. The thrust piece 10 is prestressed via screws 12 and springs 13. In this way, a metered pressing force can be produced by the defined interaction with the springs 13. The force/distance characteristic of the pneumatic unit, that is formed of a pneumatic cylinder 7 and a piston 8, can be adjusted via the pretensioning of the springs 13 and via the spring stiffness.

The transmission characteristic of the toggle-lever joint 9.1, 9.2 leads to good utilization of the pneumatic cylinder 7, because, at the beginning of the movement, i.e., when the cleaning roller 2 is not yet in contact with the printing form 1, the roller covers a great distance. During the pressing action, the knee of the toggle-lever joint 9.1, 9.2 is virtually extended. For this reason, significantly higher forces are available for pressing than the pneumatic cylinder 7 can normally supply by direct action. A further advantage of the toggle-lever mechanism resides in an extremely compact construction. Overall, the pressing force may be adjusted via a stop 16. The latter limits the displacement travel of the rod 14 and, therefore, of the pneumatic cylinder 7.

The cleaning roller 2 is configured so that it can traverse in the direction of the longitudinal axis thereof. Through the intermediary of an axial cam 17 in conjunction with a spring force, the cleaning roller experiences a traversing movement, which is produced by the rotational movement introduced by the motor 20.

As is apparent from FIG. 1, an air duct 18 is provided in the housing 5. The duct 18 is connected at one end to the suction nozzles 4.1, 4.2 and, at the other end, to the suction connection 19 illustrated in FIG. 2.

A moistening device, which is not illustrated in FIG. 2, may be provided. The moistening device may have a spray pipe, in order to apply a detergent to the cleaning roller 2.

We claim:

1. A device for cleaning a printing form for dry offset, comprising a cleaning roller settable onto and off the printing form, respective roller bearings for rotatably holding said cleaning roller at both ends thereof so that said cleaning roller is drivable, said roller bearings being displaceable perpendicularly to an axis of said cleaning roller, at least one lever joint, respectively, assigned to each of said roller bearings, and a rod operatively engageable with said lever joint for introducing a force into said lever joint.

2. The cleaning device according to claim 1, further comprising a pneumatic cylinder for applying said force to said rod, said pneumatic cylinder having an effective axis extending parallel to said cleaning roller.

3. The cleaning device according to claim 1, wherein said lever joint is a toggle-lever joint.

4. The cleaning device according to claim 3, wherein a spring is connected into a flow of force to said roller bearings for damping a pressing force applicable via said toggle-lever joint.

5. The cleaning device according to claim 3, further comprising a plurality of said toggle-lever joints, of which toggle-lever joints on the drive side and on the operator side are coupled with one another so that an angular position thereof relative to one another is adjustable.

6. The cleaning device according to claim 1, wherein said cleaning roller has a longitudinal axis, and said cleaning roller is traversible in the direction of said longitudinal axis thereof.

7. The cleaning device according to claim 1, wherein said cleaning roller is drivable so that a relative speed prevails between the circumferential surface thereof and the printing form.

8. The cleaning device according to claim 1, further comprising a suction device for sucking particles away.

9. The cleaning device according to claim 8, wherein said cleaning roller is formed with a multiplicity of boreholes opening at an outer surface of said cleaning roller, said boreholes being connected within said cleaning roller to a duct running in said cleaning roller, said duct being connectable to an external suction source.

10. The cleaning device according to claim 8, wherein said suction device has at least one suction nozzle provided with at least one nozzle lip for sucking particles away, said suction nozzle running parallel to and extending over the length of said cleaning roller, and being connectable to an external vacuum source.
